(19) United States
(12) Patent Application Publication
(10) Pub. No.: US 2011/0099336 A1
(43) Pub. Date: Apr. 28, 2011

(54) CACHE MEMORY CONTROL CIRCUIT AND CACHE MEMORY CONTROL METHOD

(75) Inventors: Kenta YASUFUKU, Kanagawa (JP); Seiji Maeda, Kanagawa (JP)

(73) Assignee: Kabushiki Kaisha Toshiba, Tokyo (JP)

(21) Appl. No.: 12/882,588

(22) Filed: Sep. 15, 2010

(30) Foreign Application Priority Data
Oct. 27, 2009 (JP) 2009-246900

(51) Int. Cl. G06F 12/08; G06F 12/00

(52) U.S. Cl. 711/143; 711/141; 711/E12.001; 711/E12.026

(57) ABSTRACT

A cache memory control circuit has a plurality of counters, each of which is provided per set and per memory space and configured to count how many pieces of data of a corresponding memory space is stored in a corresponding set. The cache memory control circuit controls activation of a tag memory and a data memory of each of a plurality of sets according to a count value of each of the plurality of counters.

### CROSS-REFERENCE TO RELATED APPLICATION(S)

This application is based upon and claims the benefit of priority from Japanese Patent Application No. 2009-246900 filed on Oct. 27, 2009; the entire contents of which are incorporated herein by reference.

### FIELD

Embodiments described herein relate generally to a cache memory control circuit and a cache memory control method and, in particular, to a cache memory control circuit and a cache memory control method for caching data in a plurality of memory spaces into a cache memory.

### BACKGROUND

Conventionally, cache memories have been widely used in processors to perform fast readout of data from a main memory. A cache memory is provided between a central processing unit (hereinafter referred to as a CPU) and a main memory.

Conventionally, when minimizing memory access latency of a cache memory whose associativity or, in other words, number of sets (also referred to as ways) is 2 or higher, a method has generally been used in which data memories of all sets are accessed and necessary data is selected from data outputted from the data memories of all sets. However, this method is problematic in that activation of the data memories of all sets results in an increase in power consumption.

Therefore, in order to reduce the power consumption of a cache memory, a cache memory having a plurality of ways and which is capable of reducing power consumption in a case of sequential access has been proposed (for example, refer to Japanese Patent Application Laid-Open Publication No. 2001-306396).

However, the proposed cache memory is problematic in that while power consumption can be reduced with respect to sequential access, power consumption cannot be reduced with respect to random access.

In addition, a method is conceivable in which data memory activation is judged only by using valid bits in a tag memory in order to prevent activation of the data memories of all sets. According to a cache memory control circuit of this method, activation can be limited to only a data memory that may be storing necessary data.

However, a cache memory control circuit of this method is problematic in that since the cache memory control circuit first accesses a cache tag and then controls chip enable of a data memory based on information obtained by the access, the number of stages of a logic path in one cycle increases, thereby preventing high frequencies from being realized.

Meanwhile, in recent years, a cache memory control circuit has been proposed in which a plurality of memory spaces are accessed by different instructions and data of the plurality of memory spaces is stored in a single cache memory.

The cache memory control circuit is problematic in that regardless of the cache memory storing only data of a particular memory space, when an access to a different memory space occurs, access to a data memory or a tag memory occurs in order to check whether data of the different memory space exists in the cache memory and power is wastefully consumed.

### BRIEF DESCRIPTION OF THE DRAWINGS

FIG. 1 is a configuration diagram illustrating a configuration of a processor system according to an embodiment of the present invention;

FIG. 2 is a diagram for describing a configuration example of address data;

FIG. 3 is a diagram for describing a configuration example of a cache memory 17;

FIG. 4 is a diagram for describing a case where data of a memory space A and data of a memory space B exist in each set;

FIG. 5 is a diagram for describing a case where data of a memory space A and data of a memory space B disproportionately exist in each set;

FIG. 6 is a flow chart for describing an example of a flow of load access processing in the cache memory 17; and

FIG. 7 is a flow chart for describing an example of a flow of cache miss processing.

### DETAILED DESCRIPTION

According to an aspect of the present invention, a cache memory control circuit that caches data of a plurality of memory spaces to a cache memory according to a plurality of types of memory access instructions can be provided, the cache memory control circuit including: a plurality of sets, each of which has a data storage unit configured to store data of the plurality of memory spaces; a plurality of counters, each of which is provided per set and per memory space and configured to count how many pieces of data of a corresponding memory space are stored in a corresponding set; and a plurality of control signal generating units, each of which is provided per set and configured to generate a control signal for controlling activation of each of the data storage units of the plurality of sets according to a count value of each of the plurality of counters respectively provided at a corresponding set.

Hereinafter, an embodiment of the present invention will be described in detail with reference to the drawings.

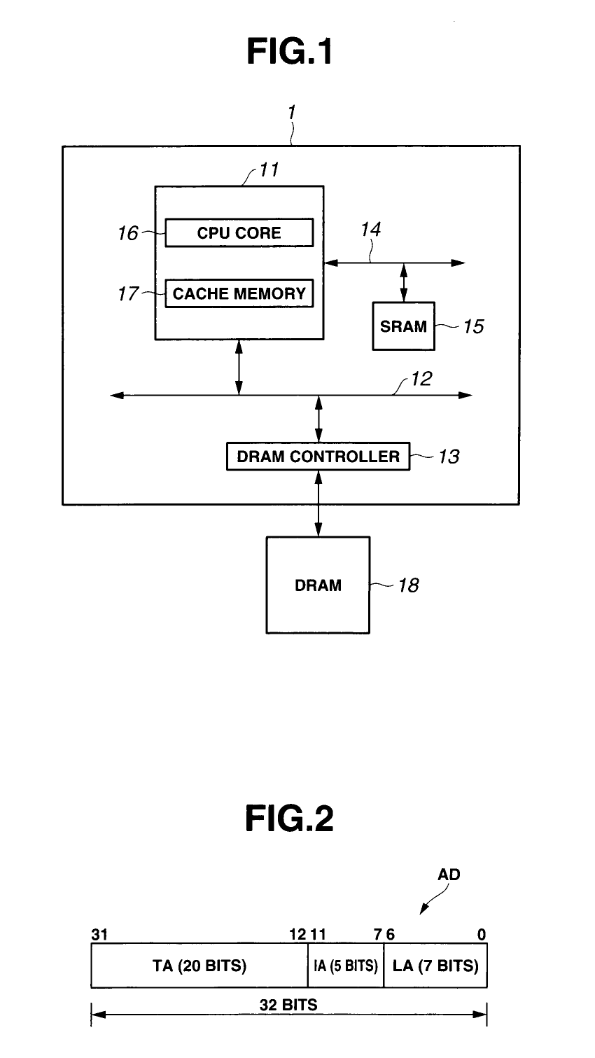

First, a configuration of a processor system including a cache memory according to an embodiment of the present invention will be described with reference to FIG. 1. FIG. 1 is a configuration diagram illustrating a configuration of a processor system according to the present embodiment.

As illustrated in FIG. 1, a processor system 1 is configured to include a CPU 11, a bus 12, a DRAM controller 13, a bus 14, and an SRAM 15. The CPU 11 includes a CPU core 16 and a cache memory 17. The processor system 1 is configured as, for example, a single-chip semiconductor device and has a DRAM 18 as a main memory outside of the chip.

The CPU 11 reads out and executes an instruction or data stored in the DRAM 18 via the DRAM controller 13, the bus 12, and the cache memory 17. In addition, the CPU 11 reads out and executes an instruction or data stored in the SRAM 15 via the bus 14 and the cache memory 17.

As described above, a configuration is provided in which a single cache memory 17 caches data of a plurality of, in this case, two memory spaces. In other words, the cache memory 17 caches data of a memory space of the DRAM 18 and data of a memory space of the SRAM 15. The memory space of the DRAM 18 shall hereby be named memory space A and the memory space of the SRAM 15 be named memory space B.

In addition, the CPU 11 respectively accesses data of the memory space A and data of the memory space B using different instructions. An instruction for accessing data in the memory space A shall be named instruction A and an instruction for accessing data in the memory space B shall be named instruction B. The instruction A and the instruction B respectively have the following instruction formats.

Instruction A RT, RA, RB: operation definition RT←MEM_A (RA+RB)

Instruction B RT, RA, RB: operation definition RT←MEM_B (RA+RB)

According to these instruction formats, an operation is executed in which values of general purpose registers, not shown, respectively specified by reference characters RA and RB are summed up, a summed value is set as address data AD for accessing data, data is read out from the memory space A or the memory space B specified by the instruction A or the instruction B, and the read out data is stored in a general purpose register, not shown, specified by reference character RT.

In addition, the cache memory 17 has a four-way set-associative configuration having four sets as will be described later, and has a cache size of 16 KB and a line size of 128 B. The configuration of the cache memory 17 need not be limited to four-way set-associative and any configuration having two or more sets such as two-way or eight-way shall suffice. Furthermore, the cache size and the line size need not be respectively limited to 16 KB and 128 B, and any cache size such as 8 KB and any line size such as 64 B shall suffice, for example.

FIG. 2 is a diagram for describing a configuration example of address data. As illustrated in FIG. 2, the address data AD has 32 bits including a tag address TA occupying 20 higher order bits, an index address IA of 5 bits, and a line address LA occupying 7 lower order bits.

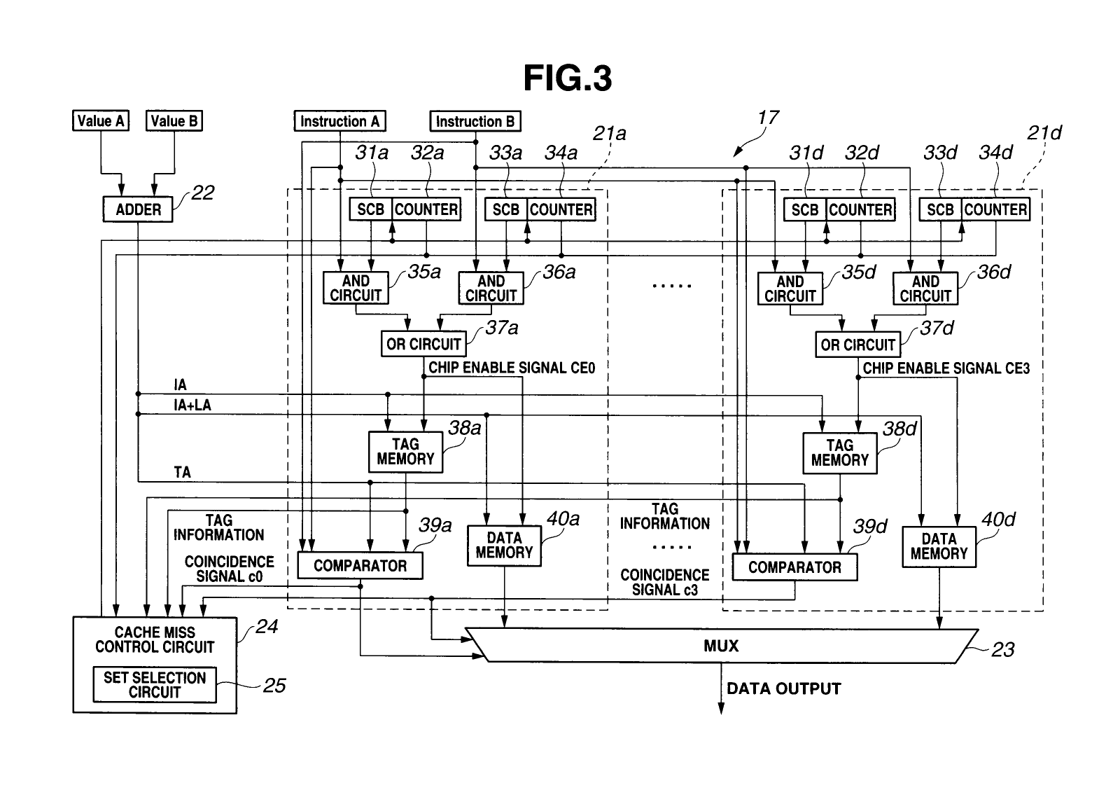

FIG. 3 is a diagram for describing a configuration example of the cache memory 17.

The cache memory 17 has a cache memory control circuit including four sets 21a, 21b, 21c, and 21d as described above, an adder 22, a multiplexer (hereinafter referred to as MUX) 23, and a cache miss control circuit 24. The cache miss control circuit 24 has a set selection circuit 25. Since the sets 21a, 21b, 21c, and 21d have similar configurations, diagrammatic representations of the sets 21b and 21c have been omitted for the sake of simplicity. In addition, since the sets 21a to 21d are configured similarly, in the following description, a configuration of the cache memory 17 will be described primarily using the set 21a.

The set 21a includes a set control bit SCB 31a for the memory space A, a counter 32a for the memory space A, a set control bit SCB 33a for the memory space B, a counter 34a for the memory space B, AND circuits 35a and 36a, an OR circuit 37a, a tag memory 38a, a comparator 39a, and a data memory 40a.

When a count value of the counter 32a is 0, 0 is set to the set control bit SCB 31a for the memory space A by the cache miss control circuit 24. When the count value of the counter 32a is other than 0, 1 is set by the cache miss control circuit 24.

The counter 32a for the memory space A counts how many lines of data of the memory space A currently exists in the set 21a. With the counter 32a, for example, when the data of the memory space A is refilled to the data memory 40a of the set 21a, 1 is added to the count value of the counter 32a of the set 21a by the cache miss control circuit 24, and when the data of the memory space A is cast out from the data memory 40a of the set 21a, 1 is subtracted from the count value of the counter 32a of the set 21a by the cache miss control circuit 24.

In addition, a count value that must be retained by each of the respective counters 32a to 32d and 34a to 34d is determined by a number that represents a maximum number of lines of data of a corresponding memory space exists in a corresponding set. Therefore, in the cache configuration according to the present embodiment whose cache size is 16 KB, line size is 128 B, and which is four-way set-associative, since 32 lines exist per set, the respective counters 32a to 32d and 34a to 34d need only count to a maximum of 32. The count values retained by the respective counters 32a to 32d and 34a to 34d are supplied to the cache miss control circuit 24.

When a count value of the counter 34a is 0, 0 is set to the set control bit SCB 33a for the memory space B by the cache miss control circuit 24. When the count value of the counter 34a is other than 0, 1 is set by the cache miss control circuit 24.

The counter 34a for the memory space B counts how many lines of data of the memory space B currently exists in the set 21a. For example, when the data of the memory space B is refilled to the set 21a on the cache, 1 is added to the count value of the counter 34a of the set 21a by the cache miss control circuit 24, and when the data of the memory space B is cast out from the set 21a on the cache, 1 is subtracted from the count value of the counter 34a of the set 21a by the cache miss control circuit 24.

As shown, the cache memory 17 has a set control bit and a counter for each set and each memory space. In other words, since the cache memory 17 has four sets 21a to 21d and caches data of two memory spaces A and B, the cache memory 17 has eight set control bits 31a to 31d and 33a to 33d and eight counters 32a to 32d and 34a to 34d.

A signal of the Instruction A and a signal from the set control bit SCB 31a are supplied to the AND circuit 35a. The AND circuit 35a performs an AND operation of the signal of the Instruction A and the signal from the set control bit SCB 31a, and outputs an operation result to the OR circuit 37a. The signal of the Instruction A takes a value of 1 when data of the memory space A is accessed and a value of 0 when data of the memory space B is accessed.

A signal of the Instruction B and a signal from the set control bit SCB 33a are supplied to the AND circuit 36a. The AND circuit 36a performs an AND operation of the signal of the Instruction B and the signal from the set control bit SCB 33a, and outputs an operation result to the OR circuit 37a. The signal of the Instruction B takes a value of 0 when data of the memory space A is accessed and a value of 1 when data of the memory space B is accessed.

The OR circuit 37a performs an OR operation on the operation result outputted from the AND circuits 35a and 36a, and outputs an operation result as a chip enable signal CE0 to the tag memory 38a and the data memory 40a. In the present embodiment, chip enable is assumed to be enabled when the chip enable signal CE0 takes a value of 1. Therefore, when the chip enable signal CE0 takes a value of 1, the tag memory 38a and the data memory 40a are activated, and when the chip enable signal CE0 takes a value of 0, the tag memory 38a and the data memory 40a are not activated.

A Value A and a Value B are supplied to the adder 22. The Value A and the Value B are values of general purpose registers, not shown, respectively specified by RA and RB. The adder 22 sums up and outputs the values of the general purpose registers. In other words, the output of the adder 22 becomes the address data AD illustrated in FIG. 2.

Among the address data AD, the index address IA is supplied to the tag memories 38a to 38d, the tag address TA is supplied to the comparators 39a to 39d, and the index address IA and the line address LA is supplied to the data memories 40a to 40d.

The tag memory 38a outputs tag information stored in a line specified by the index address IA, and the outputted tag information are supplied to the comparator 39a and the cache miss control circuit 24. Tag information stored in each line includes an 1-bit Valid, a 20-bit tag, an 1-bit Dirty, and 1-bit memory space information. The memory space information indicates whether data stored in the line is data belonging to the memory space A or to the memory space B. In the present embodiment, memory space information of 0 indicates that the data stored in the line is data belonging to the memory space A, while memory space information of 1 indicates that the data stored in the line is data belonging to the memory space B.

The comparator 39a verifies a value of Valid included in the tag information outputted from the tag memory 38a, performs a comparison to check whether the 1-bit memory space information included in the tag information outputted from the tag memory 38a and memory spaces of memory access instructions currently being executed and represented by a signal of Instruction A and a signal of Instruction B are consistent, compares the 20-bit tag included in the tag information outputted from the tag memory 38a with the tag address TA, and outputs a coincidence signal c0 to the MUX 23 and the cache miss control circuit 24. The comparator 39a judges a cache hit when the value of Valid is 1, the memory space indicated by the memory space information and the memory space of the memory access instruction currently being executed are consistent, and the 20-bit tag included in tag information and the tag address TA are consistent. The comparator 39a judges a cache miss when the value of Valid is 0, the memory spaces of the memory space information and the memory access instruction are inconsistent, or the tag and the tag address TA are not consistent. In other words, the coincidence signal c0 is a signal that indicates either a cache hit or a cache miss. Similarly, the comparators 39b to 39d respectively output coincidence signals c1 to c3 to the MUX 23 and the cache miss control circuit 24.

The data memory 40a as a data storage unit outputs data specified by the supplied index address IA and the line address LA to the MUX 23. Similarly, each of the data memories 40b to 40c outputs data specified by the supplied index address IA and the line address LA to the MUX 23.

The MUX 23 selects data outputted from the data memories 40a to 40d based on coincidence signals c0 to c3 respectively supplied from the comparators 39a to 39d, and outputs the selected data. The data is outputted to the CPU core 16 and stored in a general purpose register specified by RT.

The cache miss control circuit 24 judges a cache hit or a cache miss based on coincidence signals c0 to c3 outputted from the respective comparators 39a to 39d. When the cache miss control circuit 24 makes a cache miss judgment, the cache miss control circuit 24 performs refill and write back control. In addition, the cache miss control circuit 24 performs control of the set control bit and the counter value of the counter of the memory space of the set that has become a replace and refill object. For example, when replacing the data of the memory space A and refilling the data of the memory space B from the set 21a, the cache miss control circuit 24 decrements the count value of the counter 32a by 1 and increments the count value of the counter 34a by 1. The cache miss control circuit 24 constitutes a count value control circuit that controls the respective count values of the counters 32a to 32d and 34a to 34d.

The set selection circuit 25 selects which of the sets 21a to 21d new data is to be stored in based on a signal indicating a cache hit or a cache miss of each set upon an occurrence of a cache miss, and on count values from the counters 32a to 32d and 34a to 34d and tag information. An algorithm for selecting which of the sets 21a to 21d new data is to be stored in will be described later.

Reduction of power consumption by the cache memory 17 will now be described. For example, assume that only data of the memory space A is stored in the data memory 40a. In this case, the count value of the counter 32a is counted up by a value corresponding to the data of the memory space A stored in the data memory 40a. Therefore, since the count value of the counter 32a is not 0, 1 is set to the set control bit SCB 31a by the cache miss control circuit 24.

On the other hand, since data of the memory space B stored in the data memory 40a does not exist, the count value of the counter 34a is 0. Therefore, since the count value of the counter 34a is 0, 0 is set to the set control bit SCB 33a by the cache miss control circuit 24.

In this case, when an instruction to access data of the memory space B is supplied to the cache memory 17, 0 is supplied to the AND circuit 35a as the Instruction A and 1 is supplied to the AND circuit 36a as the Instruction B. In addition, 1 is supplied from the set control bit SCB 31a to the AND circuit 35a and 0 is supplied from the set control bit SCB 33a to the AND circuit 36a.

Therefore, each of the AND circuits 35a and 36a outputs 0 that is a result of performing an AND operation to the OR circuit 37a. As a result, the OR circuit 37a outputs 0 as the chip enable signal CE0 as a control signal to the tag memory 38a and the data memory 40a. Therefore, the tag memory 38a and the data memory 40a are not activated and a reduction in power consumption can be achieved. As shown, the AND circuits 35a and 36a and the OR circuit 37a constitute a control signal generating unit that generates control signals for controlling activation of the tag memory 38a and the data memory 40a.

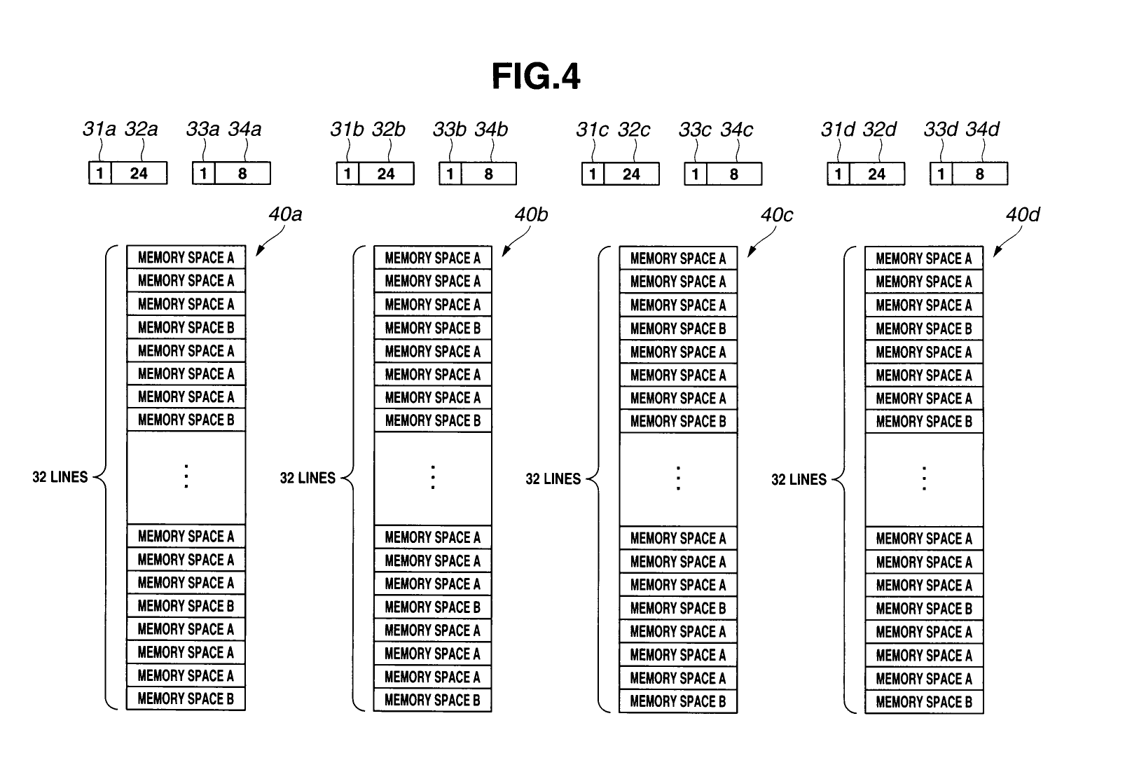

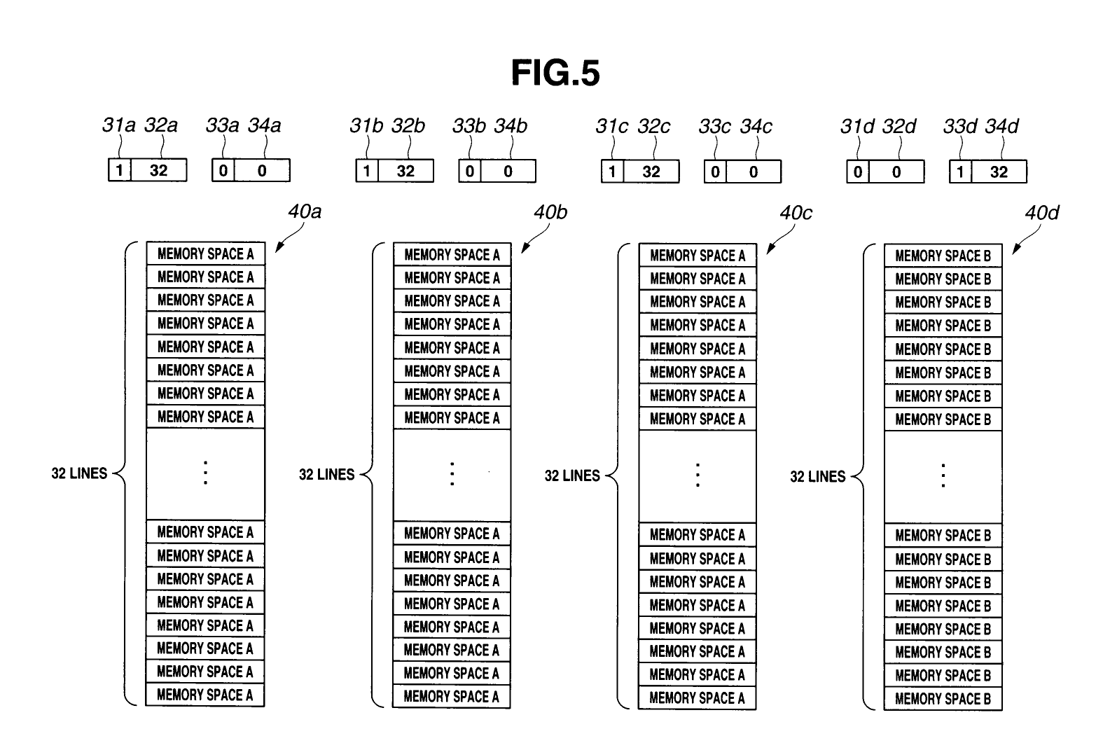

More specifically, the reduction of power consumption by the cache memory 17 will be described with reference to FIG. 4 and FIG. 5. FIG. 4 is a diagram for describing a case where data of the memory space A and data of the memory space B exist in each set, and FIG. 5 is a diagram for describing a case where data of the memory space A and data of the memory space B disproportionately exist in each set.

In a case where the number of pieces of data of the memory space A and the number of pieces of data of the memory space B existing on the cache form a ratio of 3:1, in FIG. 4, data of the memory space A and data of the memory space B evenly exist for each set 21a to 21d, and in FIG. 5, data of the memory space A and data of the memory space B disproportionately exist for each set 21a to 21d.

In FIG. 4, data of the memory space A and data of the memory space B exist in a ratio of 3:1 in the data memory 40a of the set 21a. Therefore, 24 is set to the counter 32a and 1 is set to the set control bit SCB 31a. In addition, 8 is set to the counter 34a and 1 is set to the set control bit SCB 33a. Data of the memory space A and data of the memory space B similarly exist in a ratio of 3:1 in the respective data memories 40b to 40d of the other sets 21b to 21d.

As shown, when data of the memory space A and data of the memory space B are stored in each of the data memories 40a to 40d, all sets 21a to 21d are activated when accessing data of the memory space A or data of the memory space B. In other words, all chip enable signals CE0 to CE3 are enabled, resulting in activation of the tag memories 38a to 38d and the data memories 40a to 40d.

On the other hand, in FIG. 5, only data of the memory space A is stored in each of the data memories 40a to 40c, while only data of the memory space B is stored in the data memory 40d. Therefore, the count value of each of the counters 34a to 34c and 32d become 0, and 0 is set to each of the set control bits SCB 33a to 33c and 31d.

As shown, in a case where data of the memory space A is stored in each of the data memories 40a to 40c and data of the memory space B is stored in the data memory 40d, only the tag memories 38a to 38c and the data memories 40a to 40c of the sets 21a, 21b and 21c are activated when accessing data of the memory space A, and only the tag memory 38d and the data memory 40d of the set 21d are activated when accessing data of the memory space B. As a result, reduction of the power consumption of the cache memory 17 can be enabled.

As described above, with the cache memory 17, since a tag memory and a data memory of a set not caching data of a memory space is not activated when an instruction to access the data of the memory space is executed, power consumption can be reduced. In addition, the cache memory 17 controls chip enable using an AND operation and an OR operation based on an instruction type and a set control bit. Therefore, the cache memory 17 is capable of aiming for high operating frequencies and reducing the number of accesses to the tag memory of each set as compared to controlling chip enable by accessing a tag memory with address data or, in other words, chip enable control based on address data as was conventional.

However, in the configuration of the cache memory 17 according to the present embodiment, when data of the memory space A and data of the memory space B exist in each of the sets 21a to 21d as illustrated in FIG. 4, the tag memories 38a to 38d and the data memories 40a to 40d of all of the sets 21a to 21d are to be activated every time a memory access instruction is executed.

Therefore, when selecting a set that is a cache refill object, it is necessary to disproportion the existence of the data of the memory space A and data of the memory space B for each set by referencing count values of the counters 32a to 32d and 34a to 34d and selecting a set whose count value of data in a memory space to be refilled is large as possible.

Generally, an LRU (Least Recently Used) algorithm is used when selecting a set upon a cache refill. However, in the present embodiment, as will be demonstrated below, a set upon refill is selected based on the count values of the counters 32a to 32d and 34a to 34d described above in addition to an LRU algorithm. In the present embodiment, the algorithm for selecting a set upon refill shall be referred to as a set selection algorithm. In addition, the processing described below for selecting a set upon refill is exclusively executed by the set selection circuit 25.

First, a detection is performed in regard to whether or not tag information that is Valid or, in other words, tag information whose valid bit is 0 exists among tag information of the respective sets 21a to 21d.

When there is one set with a valid bit of 0, the set is selected as a refill object and the processing is terminated.

When there is a plurality of sets with a valid bit of 0, the count values of the counters of the sets are referenced. Subsequently, a set with a maximum count value of a counter of a memory space to which an access has caused a cache miss is selected as a refill object and the processing is terminated.

At this point, if there is a plurality of sets with a same count value of a counter of a memory space to which an access has caused a cache miss, a set with a minimum count value of a counter of a memory space other than the memory space to which an access has caused a cache miss is selected as a refill object and the processing is terminated.

Furthermore, if there is a plurality of sets with a same count value of a counter of a memory space other than the memory space to which an access has caused a cache miss, a refill object set is selected according to an LRU algorithm and the processing is terminated.

On the other hand, if there is no tag information whose valid bit is 0 among the tag information of the respective sets, a most recently accessed set among information of the LRU algorithm is removed from refill objects. A count value of the counter of each set other than the removed set is referenced.

A set with a maximum count value of a counter of a memory space to which an access has caused a cache miss is selected as a refill object and the processing is terminated.

At this point, if there is a plurality of sets with a same count value of a counter of a memory space to which an access has caused a cache miss, a set with a minimum count value of a counter of a memory space other than the memory space to which an access has caused a cache miss is selected as a refill object and the processing is terminated.

Furthermore, if there is a plurality of sets with a same count value of a counter of a memory space other than the memory space to which an access has caused a cache miss, a refill object set is selected according to an LRU algorithm and the processing is terminated.

By selecting a set upon refill according to the set selection algorithm described above, the existence of data of the memory space A and data of the memory space B is disproportioned for each set, thereby enabling a reduction in power consumption during a cache access.

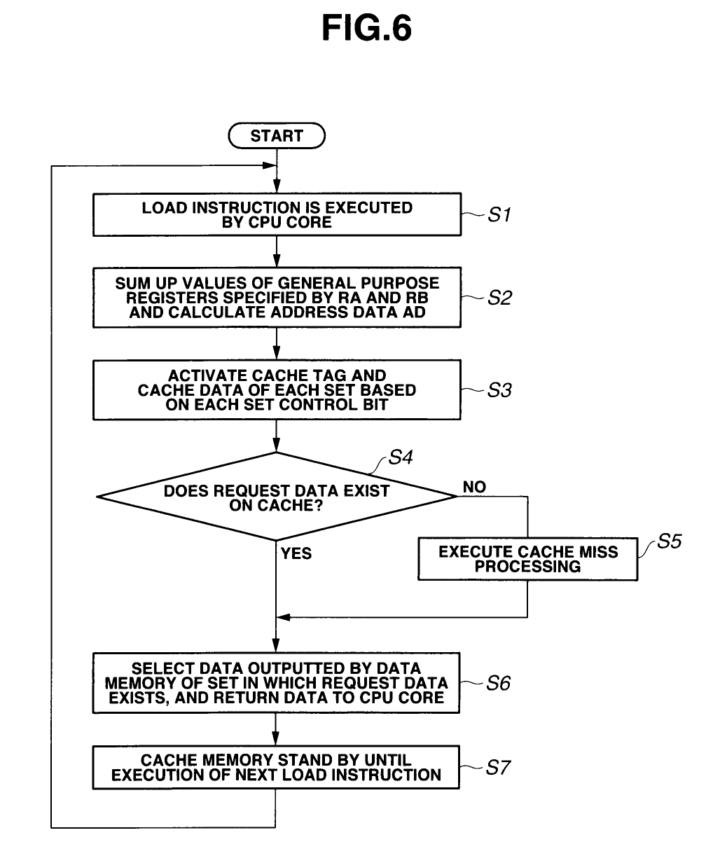

Load access processing will now be described. FIG. 6 is a flow chart for describing an example of a flow of load access processing in the cache memory 17.

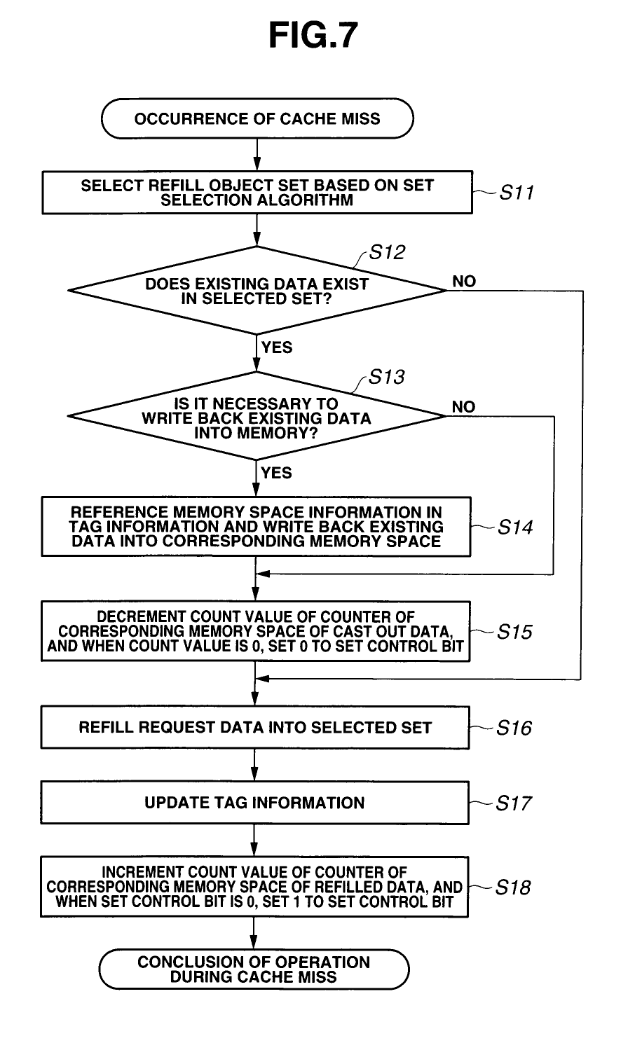

First, a load instruction is executed by the CPU core 16 (step S1). Values of general purpose registers specified by RA and RB are summed up and address data AD is calculated (step S2). A tag memory and a data memory of each set are activated based on each set control bit SCB (step S3). Next, a judgment is made on whether or not request data exists on the data memory or, in other words, on the cache (step S4). When it is judged that request data does not exist on the cache, a NO result is obtained, cache miss processing is executed (step S5), and the flow proceeds to step S6. Cache miss processing will be described in detail later using FIG. 7. On the other hand, when request data exists on the cache, a YES result is obtained, data outputted from the data memory of a set in which the request data exists is selected, and the data is returned to the CPU core 16 (step S6). Finally, the cache memory 17 stands by until execution of a next load instruction (step S7), returns to step S1 upon the execution of a load instruction, and similar processing is executed.

Next, cache miss processing to be performed in step S5 will be described. FIG. 7 is a flow chart for describing an example of a flow of cache miss processing.

First, when a cache miss occurs, a refill object set is selected based on the set selection algorithm described above (step S11). A judgment is performed on whether or not existing data is present in the selected set (step S12). In other words, in step S12, a judgment is made on whether Valid in tag information is 1 or not. When existing data is absent, a NO result is obtained and the flow proceeds to step S16. On the other hand, when existing data is present, a YES result is obtained and a judgment is made on whether or not write back of the existing data is necessary (step S13). In other words, in step S13, a judgment is made on whether Dirty in tag information is 1 or not. When a write back of the existing data is not required, a NO result is obtained and the flow proceeds to step S15. On the other hand, when a write back of the existing data is required, a YES result is obtained, memory space information in the tag information is referenced and the existing data is written back to a corresponding memory space (step S14).

Next, a count value of a counter of a corresponding memory space of cast out data is decremented, and when the count value is 0, 0 is set to the set control bit SCB (step S15). The request data is refilled to the selected set (step S16) and tag information is updated (step S17). The tag information update involves setting 1 to Valid, 0 to Dirty, an address calculated from an address of the request data to tag, and 0 or 1 to memory space information depending on a memory space of the request data.

Finally, a count value of a counter of a corresponding memory space of refilled data is incremented, and when the set control bit SCB is 0, 1 is set to the set control bit SCB (step S18). Cache miss processing is thereby concluded and the flow proceeds to step S6 in FIG. 6 described above.

As shown, the cache memory 17 is arranged so as to select which of the sets 21a to 21d new data is to be stored based on count values of the counters 32a to 32d and 34a to 34d of each set during a cache miss. In addition, the cache memory 17 is arranged so as to respectively perform OR operations on respective AND operation results of the Instruction A and set control bits SCB 31a to 31d and on respective AND operation results of the Instruction B and set control bits SCB 33a to 33d to generate chip enable signals CE0 to CE3.

As a result, with the cache memory 17, since a tag memory and a data memory of a set not caching data of a memory space is not activated when an instruction to access the data of the memory space is executed, power consumption can be reduced. In addition, the cache memory 17 controls chip enable using an AND operation and an OR operation based on an instruction type and a set control bit. Therefore, the cache memory 17 is capable of aiming for high operating frequencies and reducing the number of accesses to the tag memory of each set as compared to controlling chip enable by accessing a tag memory with an access address or, in other words, chip enable control based on an access address as was conventional.

Consequently, with a cache memory control circuit according to the present embodiment, a cache memory control circuit that caches data of a plurality of memory spaces to a cache memory is capable of reducing power consumption without reducing an operating frequency of a processor and increasing memory access latency.

Moreover, as for the respective steps in the flow charts described in the present specification, the steps may be executed in a different sequence, a plurality of steps may be executed concurrently, or the steps may be executed in a different sequence upon each execution as long as such changes are not contrary to the nature of the steps.

While certain embodiments have been described, these embodiments have been presented by way of example only, and are not intended to limit the scope of the inventions. Indeed, the novel circuits and systems described herein may be embodied in a variety of other forms; furthermore, various omissions, substitutions and changes in the form of the circuits and systems described herein may be made without departing from the spirit of the inventions. The accompanying claims and their equivalents are intended to cover such forms or modifications as would fall within the scope and spirit of the inventions.

What is claimed is:

1. A cache memory control circuit that caches data of a plurality of memory spaces to a cache memory according to a plurality of types of memory access instructions, the cache memory control circuit comprising:
a plurality of sets, each of which has a data storage unit configured to store data of the plurality of memory spaces;
a plurality of counters, each of which is provided per set and per memory space and configured to count how many pieces of data of a corresponding memory space are stored in a corresponding set; and
a plurality of control signal generating units, each of which is provided per set and configured to generate a control signal for controlling activation of each of the data storage units of the plurality of sets according to a count value of each of the plurality of counters respectively provided at a corresponding set.

2. The cache memory control circuit according to claim 1, further comprising a set selection circuit configured to reference a count value of each of the plurality of counters and select a set that is a refill object among the plurality of sets upon an occurrence of a cache miss.

3. The cache memory control circuit according to claim 2, wherein
the set selection circuit is configured to select the set that is the refill object among the plurality of sets so that only data of a same memory space is stored in each data storage unit of the plurality of sets.

4. The cache memory control circuit according to claim 2, further comprising
a count value control circuit configured to increment a count value of a counter corresponding to the set that is the refill object and to a memory space of data to be refilled upon the occurrence of the cache miss.

5. The cache memory control circuit according to claim 4, wherein
the count value control circuit is configured to decrement a count value of a counter corresponding to the set that stores data to be cast out and to a memory space of the data to be cast out upon the occurrence of the cache miss.

6. The cache memory control circuit according to claim 1, further comprising
a plurality of comparators, each of which is provided per set and configured to compare a tag included in tag information read out from the data storage unit with a tag address included in address data, to compare memory space information included in the tag information with a memory space indicated by a memory access instruction currently being executed, and to output a coincidence signal, and
a cache miss control circuit configured to judge whether the cache miss has occurred or not based on the coincidence signal outputted from each of the comparators.

7. The cache memory control circuit according to claim 6, wherein
when the cache miss control circuit judges that the cache miss has occurred, the cache miss control circuit is configured to judge whether or not it is necessary to write back data to be cast out, and when it is judged that write back is necessary, to reference memory space information included in the tag information and write back the data to be cast out to a corresponding memory space.

8. The cache memory control circuit according to claim 6, further comprising
a set selection circuit configured to reference a count value of each of the plurality of counters and select a set that is a refill object among the plurality of sets upon an occurrence of a cache miss.

9. The cache memory control circuit according to claim 8, wherein
the set selection circuit is configured to select the set that is the refill object among the plurality of sets so that only data of a same memory space is stored in each data storage unit of the plurality of sets.

10. The cache memory control circuit according to claim 8, further comprising
a count value control circuit configured to increment a count value of a counter corresponding to the set that is the refill object and to a memory space of data to be refilled upon the occurrence of the cache miss.

11. The cache memory control circuit according to claim 10, wherein
the count value control circuit is configured to decrement a count value of a counter corresponding to the set that stores data to be cast out and to a memory space of the data to be cast out upon the occurrence of the cache miss.

12. A cache memory control method for caching data of a plurality of memory spaces in a cache memory according to a plurality of types of memory access instructions, the cache memory control method comprising:
storing data of the plurality of memory spaces in a data storage unit included in each of a plurality of sets;
counting, using a plurality of counters, each of which is provided per set and per memory space, how many pieces of data of a corresponding memory space are stored in a corresponding set; and
generating, using a plurality of control signal generating units, each of which is provided per set, a control signal for controlling activation of each of the data storage units of the plurality of sets according to a count value of each of the plurality of counters respectively provided at a corresponding set.

13. The cache memory control method according to claim 12, wherein
upon an occurrence of a cache miss, a count value of each of the plurality of counters is referenced and a set that is a refill object among the plurality of sets is selected.

14. The cache memory control method according to claim 12, wherein
a set that is the refill object is selected among the plurality of sets so that only data of a same memory space is stored in each data storage unit of the plurality of sets.

15. The cache memory control method according to claim 13, wherein
upon the occurrence of the cache miss, a count value of a counter corresponding to the set that is the refill object and to a memory space of data to be refilled is incremented.

16. The cache memory control method according to claim 15, wherein
upon the occurrence of the cache miss, a count value of a counter corresponding to the set that stores data to be cast out and to a memory space of the data to be cast out is decremented.

17. The cache memory control method according to claim 16, wherein
using a plurality of comparators, each of which is provided per set, a tag included in tag information read out from the data storage unit is compared with a tag address included in address data, memory space information included in the tag information is compared with a memory space indicated by a memory access instruction currently being executed, a coincidence signal is outputted, and
a judgment is made on whether the cache miss has occurred or not based on the coincidence signal outputted from each of the plurality of comparators.

18. The cache memory control method according to claim 17, wherein
when it is judged that the cache miss has occurred, a judgment is made on whether or not it is necessary to write back data to be cast out, and when it is judged that write back is necessary, memory space information included in the tag information is referenced and the data to be cast out is written back to a corresponding memory space.
